(19) United States
(12) Patent Application Publication
(10) Pub. No.: US 2015/0079359 A1
(43) Pub. Date: Mar. 19, 2015

(54) SYSTEM AND METHOD OF GENERATING A PATTERN USED TO PROCESS A SURFACE OF A FABRIC THROUGH LASER IRRADIATION, AND FABRIC CREATED THEREBY

(71) Applicant: REVOLAZE, LLC, Westlake, OH (US)

(72) Inventor: Darryl J. COSTIN, JR., Avon, OH (US)

(21) Appl. No.: 14/491,597

(22) Filed: Sep. 19, 2014

Related U.S. Application Data
(60) Provisional application No. 61/879,844, filed on Sep. 19, 2013.
(60) Provisional application No. 61/930,082, filed on Jan. 22, 2014.

(51) Int. Cl. D06P 5/20; D06C 23/00; B41J 2/455

(52) U.S. Cl. CPC D06P 5/2005; B41J 2/455; D06C 23/00
USPC 428/196; 347/224

(57) ABSTRACT

A method of generating a pattern used to process a surface of a fabric through laser irradiation is provided. The method includes the steps of defining a pattern area having an array of pixels. A laser irradiation unit area is defined where the laser irradiation unit area includes at least one pixel. A laser irradiation unit density associated with the pattern area can be selected where the irradiation unit density corresponds to a number of laser irradiation unit indicators included in the pattern area. A plurality of laser irradiation unit indicators are arranged within the pattern area based on the laser irradiation unit density and the defined laser irradiation unit area. An effective applied power of the laser is identified for each of the plurality of laser irradiation unit indicators.

### CROSS-REFERENCE TO RELATED APPLICATION

This application claims priority to U.S. Provisional Application No. 61/879,844 filed on Sep. 19, 2013 and U.S. Provisional Application No. 61/930,082 filed on Jan. 22, 2014, the disclosures of which are incorporated herein by reference.

### BACKGROUND OF THE INVENTION

1. Field of the Invention

The present invention generally relates to a surface treatment of fabric with a laser and, more specifically, to a system and method for generating a pattern used to process a surface of a fabric through laser irradiation and the fabric resulting from such treatment.

2. Description of the Related Art

Fabric, such as denim, can be processed to simulate a worn look. Conventionally, a wet process such as a stone and/or enzyme process are applied to the fabric, typically after the fabric has been transformed into a garment, to create a faded and worn look. Specifically, an enzyme wash in combination with an agitation element, such as stones or rocks, removes color from a ridged blue denim fabric to develop a contrasting pattern of variable color intensities creating a stonewashed look. In an exemplary embodiment, the faded areas of the denim fabric can correspond to where stones or rocks contact the fabric during the enzyme washing process.

However, traditional stonewash and/or enzyme processes have numerous drawbacks. For example, each manufacturing cycle requires extensive time to create the stonewashed look where a significant amount of water is used during the process. In addition, the handling and disposal of the enzymes and wastewater can require substantial attention regarding environmental concerns.

Ring spun denim is a type of fabric that is processed into garments. Ring spun denim is a stronger, more durable fabric that includes imperfections, known as slubs. These imperfections create a unique vintage quality look. In addition, ring spun denim has a more luxurious texture because more cotton fibers are used to create the yarn for ring spun fabric than conventional denim fabric. Due to the characteristics of the yarn, ring spun fabric tends to fade more evenly, contributing to a more authentically vintage look. However, the cost of the fabric used in ring spun denim is more costly than standard denim fabric due to the relative inefficiencies in manufacturing the product.

Lasers have been proposed to process graphics and patterns onto a surface of a fabric, thereby creating different denim looks using a dry process. However, re-creating a wet process such as an enzyme wash or stonewash look using a laser processing technique is difficult due to the unique characteristics created during an enzyme wash and a stonewash. Specifically, previous methods implemented uniform, repeating patterns that might not adequately capture the contrast in color intensities to create an atheistically pleasing enzyme and stonewash pattern.

Our prior patents U.S. Pat. No. 6,495,237 and U.S. Pat. No. 6,616,710 disclose methods and systems for irradiating various substrates with a laser in order to apply a graphic to the surface. Specifically, the '710 patent discloses use of a laser to simulate an enzyme wash and the '237 patent discloses methods to create a stone wash image. Commercial implementation of those techniques, particularly implementation across full width rolls of denim, in order to create a stonewash and a ring spun image has resulted in improved techniques disclosed herein to allow even more realistic images to be lazed onto the denim through modification of the coloring of the dyed fabric.

Therefore a need exists for a method and system for generating a pattern used to process a surface of a fabric through laser irradiation that improves upon prior pattern generation methods and systems and solves the problem inherent in known laser fabric processing systems.

### SUMMARY OF THE INVENTION

According to an aspect of the invention, there is provided a method of generating a pattern used to process a surface of a fabric through laser irradiation. The method includes the steps of defining a pattern area. The pattern area can include an array of pixels. A laser irradiation unit can be defined where the laser irradiation unit area comprises at least one pixel. A laser irradiation unit density associated with the pattern area is selected where the irradiation unit density corresponds to a number of laser irradiation unit indicators included in the pattern area. A plurality of laser irradiation unit indicators are arranged within the pattern area based on the laser irradiation unit density and the defined laser irradiation unit area. The effective applied power of the laser can be identified for each of the plurality of laser irradiation unit indicators.

According to another aspect of the invention, there is provided a method of processing a surface of a fabric through laser irradiation. The method includes the steps of receiving at a control device information associated with a pattern used to process a surface of a fabric through laser irradiation. The information associated with the pattern includes a defined pattern area having an array of pixels, a defined laser irradiation unit area having at least one pixel, an indication of an arrangement of a plurality of laser irradiation unit indicators within the pattern area based on a selected laser irradiation unit density and the defined laser irradiation unit area, where the laser irradiation unit density corresponds to a number of laser irradiation unit indicators included in the pattern area, and an identification of an effective applied power of the laser for each of the plurality of laser irradiation unit indicators. The method further including the steps of translating at the control device the information associated with the pattern to be irradiated onto the surface of the fabric into instructions for a laser control device and instructing a laser control device to irradiate the pattern onto the surface of the fabric.

According to another aspect of the invention, there is provided a system configured to process a surface of a fabric through laser irradiation. The system including a pattern generating device configured to receive instructions to generate a pattern to process a surface of a fabric through laser irradiation. The patter generated by defining a pattern area at a pattern generating interface at the pattern generating device. The pattern area includes an array of pixels. The pattern is further generated by defining a laser irradiation unit area, where the laser irradiation unit area includes at least one pixel, selecting a laser irradiation unit density associated with the pattern area within the pattern generating interface, where the irradiation unit density corresponds to a number of laser irradiation unit indicators included in the pattern area, arranging a plurality of laser irradiation unit indicators within the pattern area based on the laser irradiation unit density and the defined laser irradiation unit area, and identifying an effective applied power of the laser for each of the plurality of laser irradiation unit indicators. The system further comprising a control device configured to receive instruction associated with the pattern generated at the pattern generating device and a laser control device configured to instruct a laser system to process the surface of the fabric based on the pattern generated at the pattern generating device.

According to another aspect of the invention, a method of manufacturing a garment from a fabric processed using laser irradiation is provided. The method including the steps of providing a fabric; generating a pattern at a pattern generation device to create an image to be processed on a surface of the fabric; defining a layout of elements of a garment corresponding to the fabric; processing a surface of the fabric associated with at least one element of the garment using a laser to create the image associated with the pattern; cutting the fabric after the image is processed in the surface of the fabric; and assembling a plurality of the elements into a garment.

Other aspects of the invention, including apparatus, devices, systems, converters, processes, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 illustrates a block diagram of a laser processing system for processing a surface of a fabric according to an exemplary embodiment.

FIG. 2 illustrates an exemplary laser system for processing a surface of a fabric according to an exemplary embodiment.

FIG. 3 illustrates a flow chart of an exemplary method of generating a pattern for processing a surface of a fabric according to an exemplary embodiment.

FIGS. 4 and 5 illustrate various patterns generated for processing a surface of a fabric having various laser irradiation unit areas according to exemplary embodiments.

FIGS. 6-8 illustrate various patterns generated for processing a surface of a fabric having various laser irradiation unit densities according to exemplary embodiments.

FIG. 9 illustrates a magnified portion of a pattern generated for processing a surface of a fabric according to exemplary embodiments.

FIGS. 10 and 11 illustrate various pattern generated for processing a surface of a fabric according to exemplary embodiments.

FIG. 12 illustrates a magnified portion of another exemplary pattern generated for processing a surface of a fabric according to an exemplary embodiment.

FIG. 13 illustrates another exemplary pattern generated for processing a surface of a fabric according to exemplary embodiments.

FIGS. 14-16 illustrates fabric surfaces created when the surface of a fabric is processed using the various exemplary patterns according to exemplary embodiments.

FIG. 17 illustrates a system for processing a surface of a fabric according to an exemplary embodiment.

FIG. 18 illustrates a flow chart of an exemplary method of manufacturing a garment according to an exemplary embodiment.

FIGS. 19 and 20 illustrate exemplary markers used in an exemplary method of manufacturing a garment according to an exemplary embodiment.

FIG. 21 illustrates an exemplary method of lazing an image on a surface of a fabric according to an exemplary embodiment.

### DETAILED DESCRIPTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the word “a” and “an” as used in the claims means “at least one” and the word “two” as used in the claims means “at least two”.

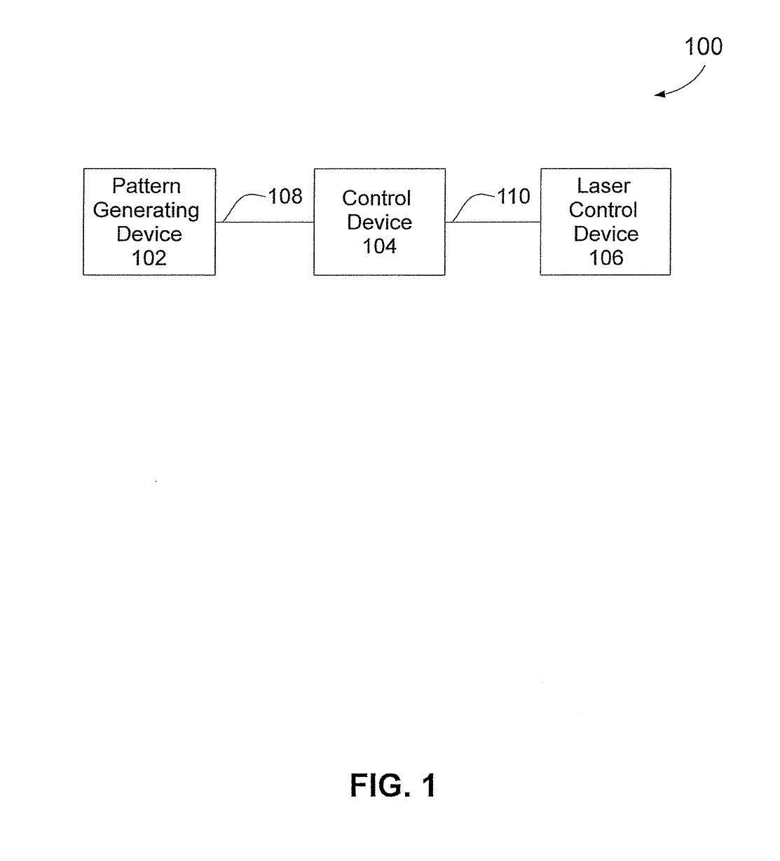

FIG. 1 illustrates a block diagram of a laser processing system for processing a surface of a fabric according to an exemplary embodiment of the present invention. The laser processing system 100 includes a pattern generating device 102, a control device 104, and a laser control system 106.

The pattern generating device 102 is configured to generate a pattern to process a surface of a fabric through laser irradiation. For example, a user can interact with pattern generating device 102 using a pattern generation interface (not shown). The pattern generation interface may be associated with various software applications such as TechnoBlast available from Technolines, LLC. or ADOBE PHOTOSHOP. A pattern area can be defined within the pattern generation interface where the pattern to process on a surface of a fabric through laser irradiation is generated within the pattern area. Various patterns can be created within the pattern area. For example, a pattern to re-create a stonewash or enzyme pattern, a pattern to re-create a ring spun pattern, or combinations thereof can be generated using the pattern generation interface.

Pattern generating device 102 includes a processor and associated circuitry to execute or direct the execution of computer-readable instructions to obtain, process, and generate information. Device 102 retrieves and executes software from storage, which can include a disk drive, a flash drive, memory circuitry, or some other memory device, and which can be local or remotely accessible. The software includes computer programs, firmware, or some other form of machine-readable instructions, and may include an operating system, utilities, drivers, network interfaces, applications, or some other type of software, including combinations thereof. For example, TechnoBlast is proprietary software may be used in carrying out the pattern-creation process described herein. In an exemplary embodiment, the “shotgun” tool of Techno Blast may be used in the pattern-creation process. Alternatively, ADOBE PHOTOSHOP is a commercially available program that may be used where the “spray tool” of ADOBE PHOTOSHOP may be used in the pattern-creation process. However, one of ordinary skill in the art would recognize that any image generation software capable of carrying out the pattern-creation process described herein may be used. Device 102 can receive instructions and other input information at a user interface. In an exemplary embodiment, the user interface of device 102 can include various peripherals such as a display, a keyboard, a mouse, a printer, etc., where at least one peripheral can be used to input the instructions associated with generating a pattern to process on a surface of a fabric through laser irradiation. Preferably, a display is provided as a peripheral and the user commences pattern creation with a blank or white image as the starting image to be transformed. The pattern can be generated a first time through the above-described process. However, creation of the pattern can be an iterative process. For example, a pattern can be generated, the fabric can be processed through laser irradiation, and the resulting fabric can be examined to determine whether the appropriate aesthetic look has been achieved. In addition, the resulting fabric can be further processed using a light or reduced wash prior to inspection. When the fabric does not achieve the appropriate aesthetic look, the pattern can be modified. For example, second laser irradiation unit indicators can be further added and arranged within the pattern area. Alternatively, a new pattern area can be defined and the parameters associated with the laser irradiation unit area and the laser irradiation unit density can be modified to create a different pattern.

Control device 104 is configured to receive information associated with the pattern generated at the pattern generation device 102, to translate the information associated with the pattern generated into instructions for the laser control device 106, and to instruct the laser control device 106 to process the surface of a fabric through laser irradiation based on the pattern generated at the pattern generation device 102. The fabric in the case of denim is colored, frequently indigo although other colors are known and may be used with the invention, and when the fabric is exposed to irradiation, dye absorbed by the fabric can remain unchanged in color, be completely removed or transformed to create white fabric, or partially removed or transformed to achieve a color between those extremes.

In an exemplary embodiment, the information associated with the pattern generated at the pattern generation device 102 is in the form of an image or pattern file such as a bitmap, etc. Based on the information included in the pattern file, the control device 104 translates the pattern information into machine instructions. For example, for each laser irradiation unit indicator, the control device 104 determines the effective applied power in which the laser is to operate. Effective applied power is the power applied to a finite area of the fabric over a finite period of time to change physical and/or chemical properties of the fabric. Various laser parameters can be modified to create the effective applied power including power level, duty cycle, frequency, pulse width, pulse period, scan speed, beam spot size, and focal distance.

In one exemplary embodiment, information associated with the effective applied power for each laser irradiation unit indicator can be included within the pattern file communicated from the pattern generation device 102. Alternatively, the control device 104 can correlate an effective applied power level based on the color intensity level of each laser irradiation unit indicator using a look up table stored in the control device 104. For instance, when a laser irradiation unit indicator is a maximum grayscale value (e.g., darker grayscale shade), the corresponding color intensity level can be a maximum level in order to create a laser irradiated area on a surface of the fabric that has high contrast with respect to the original color of the fabric. In other words, when a laser irradiation unit indicator is black, it corresponds to a maximum effective applied power that creates an area on the fabric that removes substantially all of the dye within the area on the fabric (e.g., the color of the area on the fabric is white). When a laser irradiation unit indicator is a minimum grayscale value (e.g., lighter grayscale shade), the corresponding color intensity level can be a minimum level in order to create a laser irradiated area on a surface of the fabric that has low contrast with respect to the original color of the fabric. In other words, when a laser irradiation unit indicator is the lightest grayscale shade, it corresponds to a minimum effective applied power that creates an area on the fabric that removes the least amount of dye within the area on the fabric (e.g., the color of the area on the fabric is slightly lighter than the original color of the fabric). While the above example describes a correlation between the grayscale shade level and the effective applied power level, a user can also selectively identify and correlate a laser irradiation unit indicator to any effective applied power level and utilize any color scale. In an exemplary embodiment, a user can define grayscale values 0-2 to equal 100% of the effective applied power level, 3-5 equal to 99%, etc.

Control device 104 includes a processor and associated circuitry to execute or direct the execution of computer-readable instructions to obtain, process, and generate information. Device 104 retrieves and executes software from storage, which can include a disk drive, a flash drive, memory circuitry, or some other memory device, and which can be local or remotely accessible. The software includes computer programs, firmware, or some other form of machine-readable instructions, and may include an operating system, utilities, drivers, network interfaces, applications, or some other type of software, including combinations thereof.

Laser control device 106 is configured to control various parameters of the laser to process a pattern on a surface of a fabric through laser irradiation. For example, laser control device 106 can modify the effective applied power level by adjusting at least one of power level, duty cycle, frequency, pulse width, pulse period, scan speed, beam spot size, and focal distance associated with the laser in order to create the pattern on the surface of the fabric based on the instructions provided by control device 104. Power intensity may be modified by turning the laser beam on and off, changing the output power level of the laser, etc. The duty cycle may be modified to create a continuous beam or a pulsing beam where the duty cycle is ratio of the time a laser is on and a time the laser is off. For example when the duty cycle and frequency are selected to pulse the laser beam at a certain level, the resulting pattern formed on the surface of the fabric is an intermittent line where unprocessed, or non-color modified, spaces are formed between adjacent processed, or color modified, portions of the pattern. Alternatively, when the duty cycle and frequency are selected such that a continuous beam is created, the resulting pattern formed in the surface of the fabric is a solid line of processed portions associated with the generated pattern.

Alternatively, the duty cycle may be the percentage of the laser pulse used to supply power to the laser. For example, the duty cycle may be modified to create a contrast within the pattern where different laser irradiation units have different grayscale level distributions, with each grayscale level being correlated with an effective applied power level being applied to the fabric by the impinging laser beam. A minimum power supplied to the laser can correspond to the minimum grayscale value (e.g., the darkest modified color intensity of the fabric) of the pattern and is scaled proportionally to create the full grayscale color values identified. The scan speed may be modified to create various speeds at which the laser is scanned above the fabric to process the surface of the fabric. For example, the higher the scan speed, the lower the effective applied power impinging upon the surface of the fabric because the laser irradiates a selected area for a reduced amount of time. Slow scan speeds increase the effective applied power impinging upon the surface of the fabric because the laser irradiates a selected area for a longer period of time. Modifying the beam spot size results in a change in the area in which the laser irradiates the surface of the fabric where the beam spot size can be modified by changing the focal distance. The smaller the selected beam spot size, the smaller the area impinging upon the surface of the fabric by the laser. The larger the beam spot size, the larger the area impinging upon the surface of the fabric by the laser.

Laser control device 106 includes a processor and associated circuitry to execute or direct the execution of computer-readable instructions to obtain, process, and generate information. Device 106 retrieves and executes software from storage, which can include a disk drive, a flash drive, memory circuitry, or some other memory device, and which can be local or remotely accessible. The software includes computer programs, firmware, or some other form of machine-readable instructions, and may include an operating system, utilities, drivers, network interfaces, applications, or some other type of software, including combinations thereof

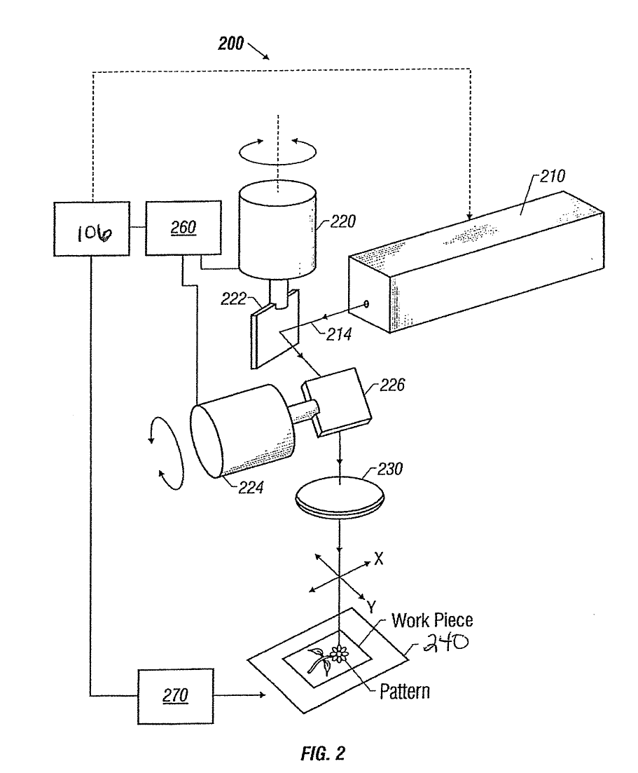

FIG. 2 illustrates an exemplary laser system 200 for processing a surface of a fabric according to an exemplary embodiment of the present invention. FIG. 2 illustrates the pre objective scanning architecture option where the scanning mirrors 222 and 226 are located before the focus or objective lens 230. However, laser system 200 can alternatively include a post objective scanning architecture where the scanning mirrors 222 and 226 are located after the focus or objective lens 230. System 200 includes a laser 210 configured to produce a laser beam having a variable effective applied power level. Laser 210 preferably has an effective power of 2500 to 5000 Watts or more. Laser 210 can be a CO₂ laser or a YAG laser. Laser 210 can further include an electrically controllable beam shutter (not illustrated) to turn the beam on and off as desired.

Laser 210 generates a laser beam 214 in the direction of a beam steering and scanning device having a first mirror 222 and a second mirror 226. The mirror 226 is mounted on a first galvanometer 220 so that the mirror 222 can be rotated to move the beam in an x-axis on the support stage 240. A second galvanometer 224 is used to control the mirror 226 so that the mirror 226 can move the beam on the support stage 240 along a y-axis. In other words, mirrors 222 and 226 can be controlled to scan the laser beam on the support stage 240 to generate any trace or geometric shape associated with the generated pattern to process the surface of the fabric through laser irradiation. A galvanometer driver 260 receives commands including numerical control commands from laser control device 106 and respectively controls the movement of each mirror 222, 226.

Laser beam 214 is deflected first by the x-axis mirror 222 and subsequently by the y-axis mirror 226 to direct the beam through a focusing lens 230. The lens 230 is preferably a multi-element, flat-field, focusing lens assembly, which is capable of optically maintaining the focused spot on a flat plane as the laser beam moves across the material. A movable stage (not shown) may be used to hold the lens 230 so that the distance between the lens 230 and the support stage 240 can be changed to alter the beam spot size. Alternatively, the support stage 240 can be moved relative to the lens 230. The support stage 240 has a working surface which can be almost any substrate including a table, or even a gaseous fluidized bed. A work piece (e.g., fabric to be processed through laser irradiation) is placed on the working surface. Usually, the laser beam is directed generally perpendicular to the surface of the support stage 240, but it may be desirable to guide the beam to the surface with an angle to achieve certain effects. For example, the incident angle may range between about 45 and about 135°.

The system 200 may also include a gas tank 270 to inject a gas such as an inert gas into the working zone over the support stage 240. The amount of gas can be controlled by laser control device 106. This use of inert gas may reduce the tendency for complete carbonization, burn-through and/or melting at the surface of the fabric during processing. The gas tank 270 can also be used to inject a gaseous dye to add additional or alternative coloring to the work piece.

In operation, a user defines a pattern area within the pattern generation interface at the pattern generating device 102. The pattern area can include an array of pixels. A user can further define a laser irradiation unit area. The laser irradiation unit area corresponds to the smallest unit area in which the laser impinges on the surface of the fabric to be processed by laser irradiation. The laser irradiation unit area can comprise one or more pixels. The user further select a laser irradiation unit density associated with the pattern area. The laser irradiation density corresponds to a number of laser irradiation units included in the pattern area. A plurality of laser irradiation units are arranged within the pattern area based on the laser irradiation unit density selected by the user. In addition, an effective applied power of the laser is assigned to each of the plurality of laser irradiation units. The effective applied power correlates to properties of the laser beam at the point in which the laser beam impinges upon the fabric to be processed through laser irradiation. After the pattern is generated at the pattern generating device 102, it is communicated to the control device 104. The pattern can be communicated between the pattern generating device 102 and the control device 104 over a wired or wireless communication link 108. Control device 104 translates the pattern into laser beam instructions and communicates the instructions to the laser control device 106 over a wired or wireless communication link 110. Laser controller device 106 processes the surface of the fabric through laser irradiation based on the instructions received at the laser control device 106 from the controller device 104 and the pattern generated at the pattern generating device 102.

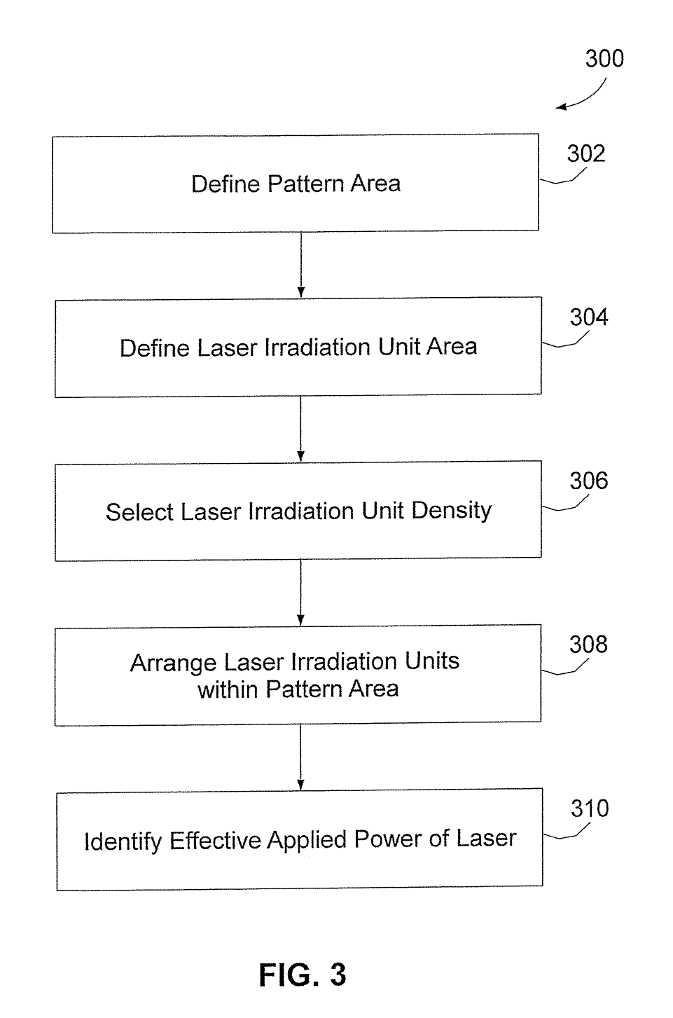

FIG. 3 illustrates a flow chart of an exemplary method 300 for generating a pattern used to process a surface of a fabric through laser irradiation. The method will be discussed with reference to the exemplary laser patterning systems 100 and 200 illustrated in FIGS. 1 and 2. However, the method can be implemented with any suitable laser patterning system. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, and/or adapted in various ways.

At 302, a pattern area is defined. For example, a user defines a pattern area within a pattern generation interface at the pattern generating device 102. The pattern area includes a two-dimensional array of pixels. For instance, the pattern area can be defined to include various field sizes such as 10×10, 20×20, 50×50, etc. where the field size may be in inches or millimeters. Laser irradiation units are arranged within the pattern area to create a pattern to be processed onto a surface of a fabric through laser irradiation. The pattern area can be defined by the user through manipulation at the interface to have any shape such as square, rectangular, circular, oval, hexagonal, etc. The defined pattern area correlates to a pattern processed on a surface of a fabric through laser irradiation. In an exemplary embodiment, the defined pattern area can be repeated along the length and width of the fabric such that each of the defined pattern areas are aligned and arranged adjacent to each other. For example, fabric is frequently created on rolls, and implementation of the invention allows the pattern to be applied across the width of a roll and also along its length, thus allowing the entire surface of the roll to be treated. Further, due to the flexibility of use of pattern creation device 102, different patterns may be created and applied across the roll.

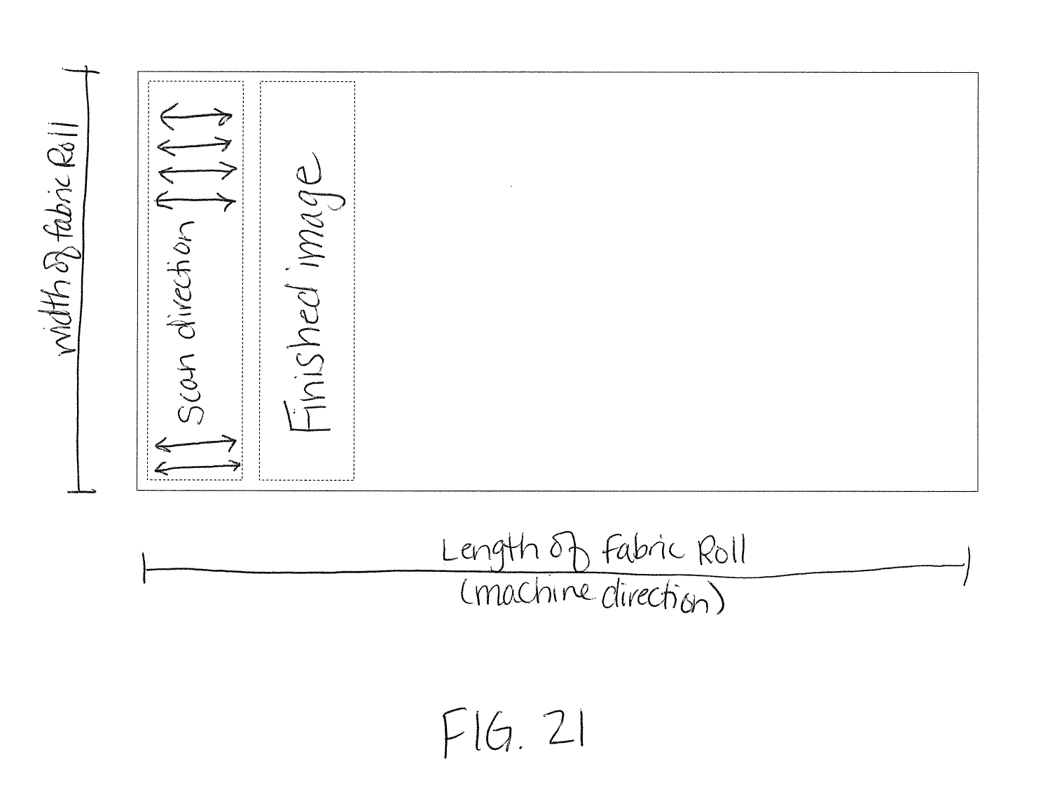

In an exemplary embodiment, as best illustrated in FIG. 21, a fabric roll is processed to create a pattern on the surface of the fabric where the pattern is created using scan lines applied in the direction of the length of the fabric. The scan lines can be applied to the fabric within a pattern area. The pattern area can be defined to have a width corresponding to a width of the fabric roll. In addition, the length of the pattern area can be selected to be any dimension. For example, when the fabric roll has a width of 60 inches, a pattern can be created to have an area that is 60 inches wide (e.g., corresponds to the entire width of the roll) and 6 inches in length where the pattern is then repeated every 6 inches along the length of the fabric roll. While 6 inches is used as an exemplary length dimension of the pattern area, one of ordinary skill in the art would recognize that any length can be selected. As the laser processes the surface of the fabric to include the pattern, the laser beam is scanned along the length of the fabric (e.g., each scan line corresponds to the 6 inches dimension of the pattern area) as the laser beam head is translated across the width of the fabric roll. After the image corresponding to the pattern is created within the 60×6 area of the roll, the next pattern area is created in the surface of the fabric roll adjacent to the previously processed area. It is noted that the pattern area is illustrated in FIG. 21 to be slightly less than the width and spaces between images created in the fabric for clarity and ease of illustration. However, preferably, the pattern areas are juxtaposed, one pattern area directly adjacent to another, such that adjacent pattern areas do not overlap on the surface of the fabric. In addition, it is further preferred that the pattern area is equal to the width of the fabric roll rather than slightly less as illustrated in FIG. 21. The dimensions of the pattern area and drawing direction on the denim roll can change depending upon the type of graphic and size of the denim roll. For example, while the scanning direction is described as occurring in the length direction of the fabric roll, the scanning direction could alternatively be in the width direction, or performed on the bias (e.g., in a diagonal direction) of the fabric.

A laser irradiation unit area is defined at 304. For example, a user can define a laser irradiation unit area within the pattern generation interface at the pattern generating device 102. The laser irradiation unit area is the smallest area within the pattern used to create the pattern where each laser irradiation unit equals the laser irradiation unit area. The laser irradiation unit area can defined to include at least one pixel of the pixel array of the pattern area. In an exemplary embodiment, the laser irradiation unit area can be defined to include 1-5 pixels of the array of pixels within the pattern area to generate a pattern having the intensity density needed to re-create a stonewash and enzyme, or other pattern. However, more pixels can be selected depending on the desired pattern. For instance, when a ring spun pattern is generated, the laser irradiation unit area corresponds to the lines created within the pattern. Thus, the laser irradiation unit area is selected to be a line having parameters including a minimum and maximum length of a line and a minimum and maximum width of the line. Various minimum and maximum lengths and widths can be selected. For example, a range of lengths can include 5-100 pixels and a range of widths can include 1-5 pixels.

In addition, the laser irradiation unit area can have various shapes such as a square, a circle, a slice, and a line. In an exemplary embodiment, each pixel of the laser irradiation unit area can have one or more of the various shapes. In other words, all of the pixels within the defined laser irradiation unit area can have the same shape or different pixels can have different pixel shapes within a single defined laser irradiation unit area. Alternatively, the laser irradiation unit area as a whole can have one of the various shapes such that the shape of the laser irradiation unit area can be a square, a circle, a slice, or a line.

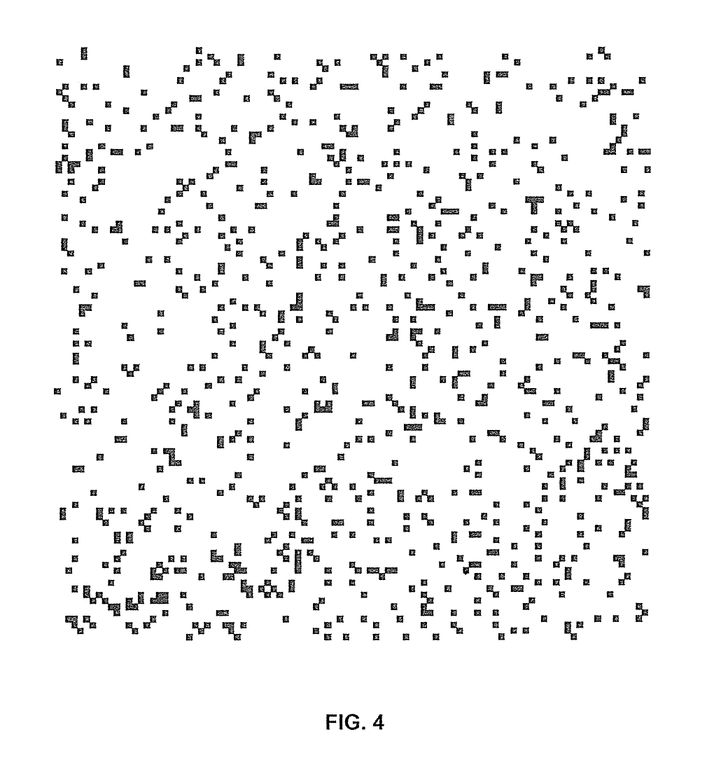

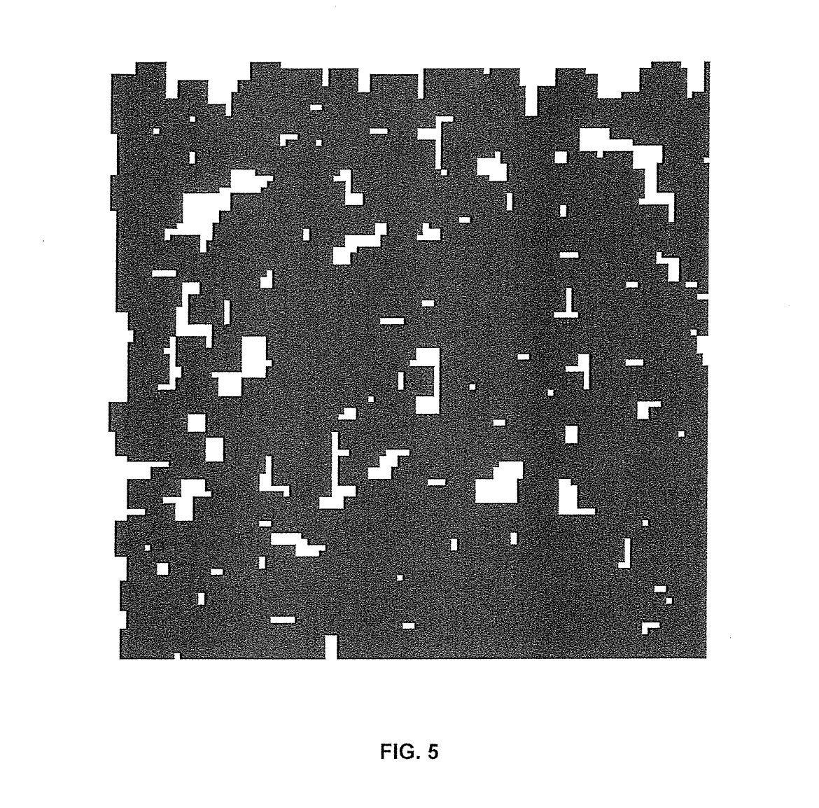

FIGS. 4 and 5 illustrate the different coverage densities within the pattern based on the selected laser irradiation unit area. For example, FIG. 4 illustrates an exemplary embodiment having a laser irradiation unit area defined as one pixel and FIG. 5 illustrates an exemplary embodiment having a laser irradiation unit area defined as five pixels. The larger the area selected for the laser irradiation unit area, the greater the coverage within the defined pattern area. In other words, when the laser irradiation unit area is defined to be a larger number of pixels, each laser irradiation unit is larger which results in a larger area of the surface of the fabric being processed through laser irradiation. The amount of coverage of laser irradiation unit areas created within the pattern is based on the defined laser irradiation unit area and the selected laser irradiation unit density. The larger the defined laser irradiation unit area and the higher the selected laser irradiation unit density, the more coverage is created within the pattern area.

When the laser irradiation unit area is defined to include more than one pixel, adjacent laser irradiation unit areas can overlap such that one pixel can correlate to more than one laser irradiation unit area. If the grayscale or color intensity values of the two adjacent laser irradiation unit areas are different, the overlapping area can be determined in various ways. For example, the overlapping pixel can be selected to include a laser irradiation unit indicator associated with one of the two laser irradiation unit areas. In other words, if one laser irradiation unit area is gray and one laser irradiation unit is black and the black laser irradiation unit is selected, the overlapping pixel associated with both the gray laser irradiation unit area and the black laser irradiation unit area would result in a laser irradiation unit indicator of black within that pixel. Alternatively, the resulting laser irradiation unit indicator of the overlapping pixel can be determined by averaging the two grayscale or color intensity levels together to create a laser irradiation unit indicator associated with the overlapping pixel that has different intensity level from the adjacent laser irradiation unit areas. If ADOBE PHOTOSHOP is used for pattern generation, typically the average color will be used.

At 306, a laser irradiation unit density associated with the pattern area is selected. For example, a user can select a laser irradiation unit density associated with the pattern area within the pattern generation interface at the pattern generating device 102. A laser irradiation unit density correlates to a number of laser irradiation units included in the pattern area. Each laser irradiation unit corresponds to the smallest unit area in which the laser irradiates the surface of the fabric. In an exemplary embodiment, when a small percentage of laser irradiation unit density is selected, a small number of laser irradiation units are arranged within the pattern area and when a large percentage of laser irradiation unit density is selected, a large number of laser irradiation units are arranged within the pattern area. In other words, when a small number of laser irradiation units are arranged within the pattern area, a low contrast pattern is created on the surface of the fabric such that a larger number of pixels within the pattern are not processed on the surface by the laser creating a fabric having an overall darker color. When a large number of laser irradiation units are arranged within the pattern area, a larger area of the pattern area will be processed through laser irradiation creating a fabric having an overall lighter color, with respect to the original color of the fabric.

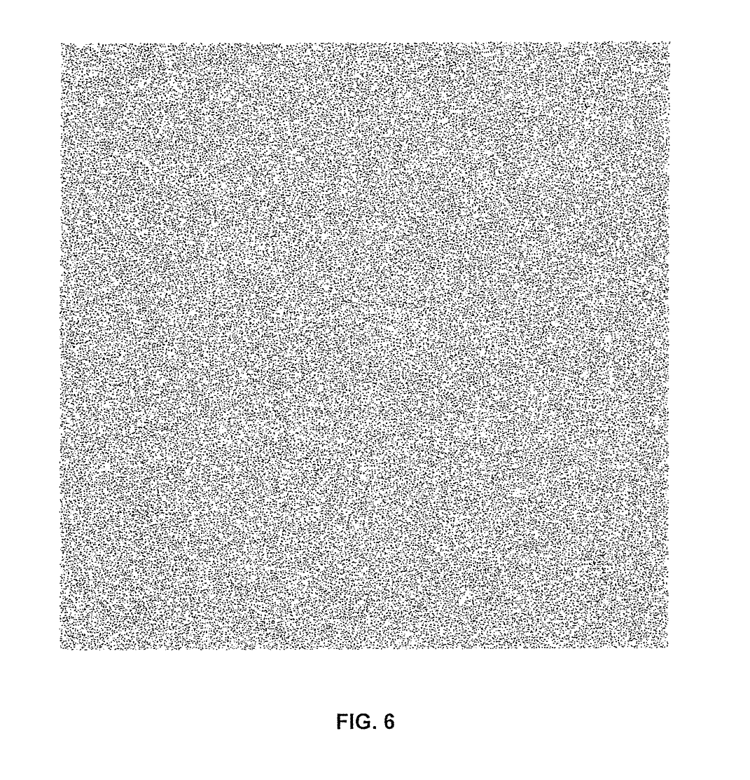

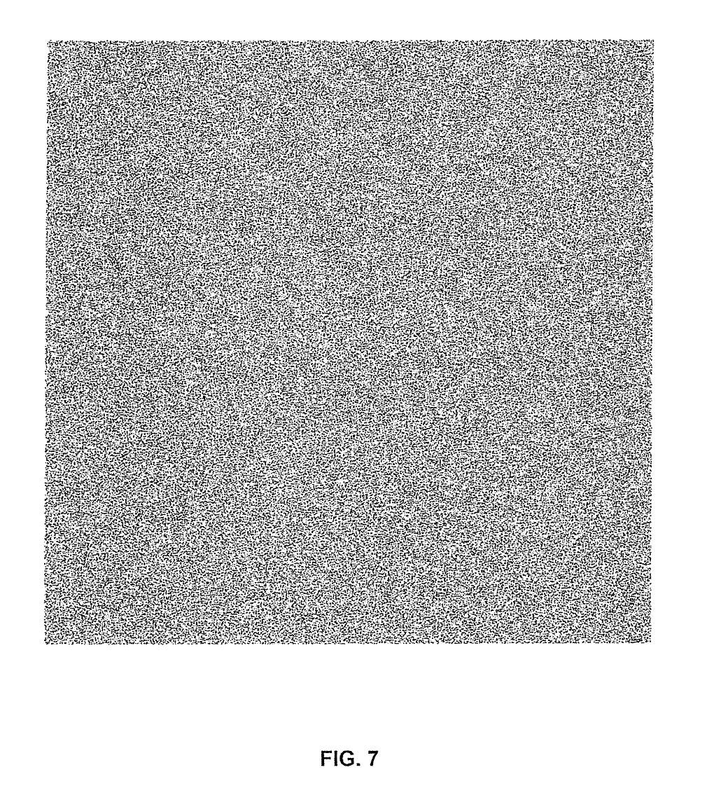

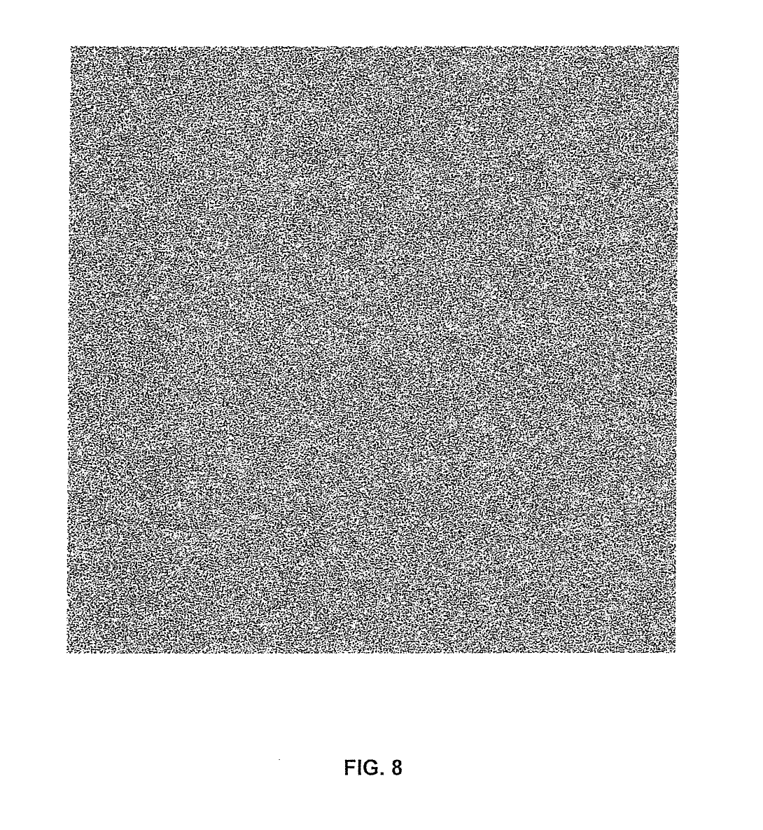

In addition, when a larger number of laser irradiation units are arranged within the pattern area, a higher contrast pattern can be created on the surface of the fabric because different laser irradiation units can be associated with different grayscale intensity values. FIGS. 6-8 illustrate exemplary embodiments of various laser irradiation unit densities where the laser irradiation unit area is defined to be the same for each example. For example, FIG. 6 illustrates a pattern having a laser irradiation unit density of 20%, FIG. 7 illustrates a pattern having a laser irradiation unit density of 50%, and FIG. 8 illustrates a pattern having a laser irradiation unit density of 70%.

In an exemplary embodiment, the laser irradiation unit density can be based on a percentage such that the percentage correlates to a probability that a pixel within the pattern area will be selected as a laser irradiation unit. After the laser irradiation unit density is selected, each pixel within the pixel array of the pattern area is sequentially identified and a decision is made as to whether to identify the selected pixel as a laser irradiation unit. Whether or not a pixel is selected is based on the defined laser irradiation unit area, the selected laser irradiation unit density, and the pattern being created. The decision to select a pixel as a laser irradiation unit can be further based on a shape of the laser irradiation unit area and a color intensity value associated with the laser irradiation unit. In an exemplary embodiment, the decision whether a pixel is selected can be performed based on a random number generator where the likelihood of a pixel being selected is based on the selected laser irradiation unit density.

In an exemplary embodiment, when a pattern area is defined to include a focal area of 100 pixels by 100 pixels (e.g., 10000 total pixels, 100 pixels within each row in a horizontal direction (x-direction) and 100 rows in the vertical direction (y-direction)), a laser irradiation unit area is defined to be one pixel, and a laser irradiation unit density is selected to be 10%, the number of laser irradiation units defined within the pattern area would equal approximately 1000 pixels. When a random number generator is used to determine the number of laser irradiation units, one of ordinary skill in the art would recognize that the total number of laser irradiation units could be slightly greater than or slightly less than the 1000 pixels due to the inherent properties of the random number generator. When a second laser irradiation unit density is selected to be included within the pattern area at the same 10% level, another 1000 laser irradiation unit indicators are arranged within the pattern area such that a total of approximately 2000 laser irradiation unit indicators are included in the pattern area. However, one of ordinary skill in the art would appreciate that a number of the second laser irradiation unit indicators may overlap the first laser irradiation unit indicators already arranged within the pattern area.

In another exemplary embodiment, the pattern area density can be defined to be 100% where each pixel within the pattern area includes a laser irradiation unit indicator. In this situation, the resulting image created on the surface of the fabric would remove at least a portion of the dye from each area within the fabric. In other words, the overall base color of the fabric would no longer correspond to the original color of the fabric. Instead, the darkest resulting area on the surface of the fabric would be lighter in color than the original color.

Laser irradiation units are arranged within the pattern area at 308. For example, when a pixel is selected to be a laser irradiation unit, a laser irradiation unit indicator is illustrated within the pattern area. The laser irradiation unit indicator has an area equal to the defined laser irradiation unit area. When a shape of the laser irradiation unit is selected, the laser irradiation unit indicator has the shape selected by the user. In addition, the laser irradiation unit indicators can represent various color intensities. For instance, laser irradiation unit indicators can correspond to different colors or different color intensities to be created on the surface of the fabric by dye modification attributable to laser processing.

In an exemplary embodiment, the following parameters can be input into the pattern generating device 102 by a user to create an enzyme and stonewash pattern. A laser irradiation unit area in the range of 1-3 pixels, a laser irradiation unit density associated with the pattern area in the range of 10-80%, number of colors included within the pattern area 3-10, and the number of times the laser irradiation unit density is selected can be in the range of 1-3. The following parameters can be input into the pattern generating device 102 by a user to create a ring spun pattern. A laser irradiation unit area size can be selected to be a line, the smallest irradiation unit area can be selected to have a length in the range of 5-100 pixels and a width of 1-3 pixels, a laser irradiation unit density can be selected to be in the range of 20-100%, the number of colors included within the pattern area can be selected to be in the range of 3-10, and the number of times the laser irradiation unit density is selected can be in the range of 1-15.

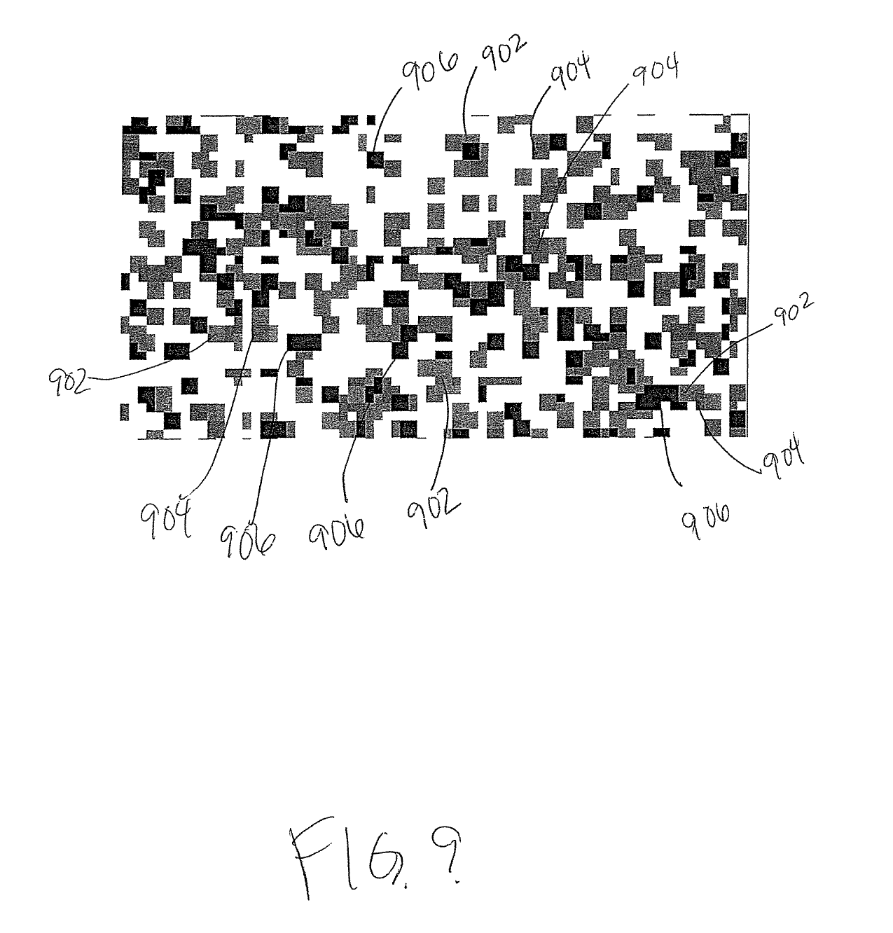

FIG. 9 illustrates an enlarged portion of a pattern area of an exemplary embodiment after laser irradiation unit indicators have been arranged. In the exemplary embodiment illustrated in FIG. 9, three different colors or color intensities were selected to be included within the number of laser irradiation unit indicators. Laser irradiation unit indicators 902 correspond to a first color or color intensity, laser irradiation unit indicators 904 correspond to a second color or color intensity, and laser irradiation unit indicators 906 correspond to a third color or color intensity. One of ordinary skill in the art would recognize that while three different color or color intensity laser irradiation unit indicators are illustrated in FIG. 9, any number of color or color intensity laser irradiation unit indicators can be selected. For example, up to 256 different grayscale values can used to generate a pattern to process a surface of a fabric through laser irradiation and thus up to 256 different laser irradiation unit indicators can be used.

At 310, an effective applied power of a laser can be identified. For example, an effective applied power of a laser can be identified for each of the laser irradiation unit indicators. In an exemplary embodiment, the effective applied power of the laser irradiation indicators corresponding to a single color or color intensity can be the same. An effective applied power correlates to properties of the laser beam at the point at which the laser beam impinges upon the fabric to be processed through laser irradiation. Therefore, when a higher effective applied power is selected to correspond to a laser irradiation unit indicator, the resulting area of the fabric processed through laser irradiation is lighter than the resulting area of the fabric processed through laser irradiation at a lower effective applied power.

In an exemplary embodiment, the user individually identifies the effective applied power for each laser irradiation unit indicator or each type of laser irradiation unit indicator within the pattern generator interface of the pattern generator device 102. However, pattern generator device 102 and/or control device 104 can automatically correlate an effective applied power to each laser irradiation unit indicator or each type of laser irradiation unit indicator. The correlation between the effective power of the laser and the laser irradiation unit indicators can be done in various ways. For example, the different effective powers of the laser can be stored as a look up table where a specific laser irradiation unit indicator level is defined to be a specific effective power level.

When the total number of laser irradiation unit indicators within the pattern includes two or more different laser irradiation unit indicator types (e.g., different colors or different color intensity values), the number of laser irradiation unit indicators can vary for each type. For example, a number of first laser irradiation unit indicators can be less than a number of second laser irradiation unit indicators. In an exemplary embodiment, when the first laser irradiation unit indicators are selected to be associated with a first color or color intensity, and the second laser irradiation unit indicators are selected to be associated with a second color or color intensity, the number of first laser irradiation unit indicators within the pattern area can be greater than or less than the number of second laser irradiation unit indicators depending on the resulting contrast and intensity desired on the surface of the fabric. When the resulting fabric is desired to be darker, a greater number of laser intensity unit indicators can be included within the pattern area that are identified as having a lower effective power level than a number of laser intensity unit indicators having a higher effective power level. When the resulting fabric is desired to be lighter, a greater number of laser intensity unit indicators can be included within the pattern area that are identified as having a higher effective power level than a number of laser intensity unit indicators having a lower effective power level. Alternatively, the number of laser irradiation unit indicators for each type of color or color intensity can be selected to be the same.

In an exemplary embodiment, a first laser irradiation unit density and a second laser irradiation unit density can be selected where a plurality of first laser irradiation unit indicators are arranged within the pattern area before the second laser irradiation unit indicators are arranged within the pattern area. The second irradiation unit density can be selected before or after the first laser irradiation unit indicators are arranged within the pattern area. The second laser irradiation unit indicators are arranged after the first laser irradiation unit indicators are arranged within the pattern area. In an exemplary embodiment, at least one of the second laser irradiation unit indicators overlaps at least one of the first laser irradiation unit indicators within a single pixel. When a first laser irradiation unit indicator and a second laser irradiation unit indicator are arranged within a single pixel of the pattern area, the second laser irradiation unit is selected as the irradiation unit to be processed onto the surface of the fabric through laser irradiation. The first laser irradiation unit indicator can be identified to have the same or different effective applied powers as the second laser irradiation unit indicator in this embodiment. For example, when the second laser irradiation unit density is selected to increase the total number of laser irradiation unit indicators and the effective applied power of the first laser irradiation unit indicator and the second laser irradiation unit indicator are the same, the pattern surface of the fabric can result in a color that is lighter due to the increased in amount of area that is processed using the laser. When the second laser irradiation unit density is selected to increase the various levels of color intensity, the effective applied power associated with the first laser irradiation unit indicators can be different from the effective applied power associated with the second laser irradiation unit indicators. This creates a pattern that provides greater contrast within the surface of the fabric after being processed by the laser.

In an alternative embodiment, an average of the first unit indicator and the second unit indicator color intensity levels can be determined where the pixel associated with the overlapping indicator corresponds to the average color or intensity level. If the first unit indicator has a low effective applied power and the second unit indicator has a high effective applied power, the two colors intensity levels can be blended together to form a medium effective applied power.

While two laser irradiation unit indicators are described above, one of ordinary skill in the art would recognize that any number of laser irradiation indicators can be used. Specifically, the number of irradiation unit indicators included within the pattern corresponds to the number of colors or color intensities selected by the user. In addition, laser irradiation unit indicators can be distributed within the pattern area simultaneously or sequentially. When the different laser irradiation unit indicators are distributed sequentially, the laser irradiation unit indicator associated with a color or color intensity level can be stored as separate image files or separate layers where the layers can be sent to the control device 104 separately or the pattern generation device 102 can combine all the layers together prior to sending the pattern information to the control device 104.

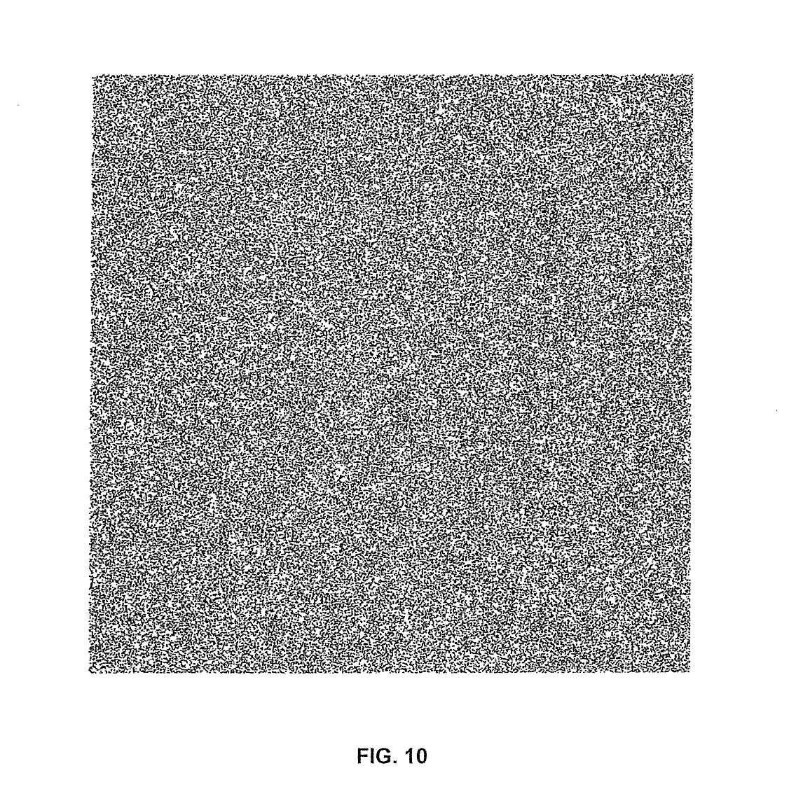

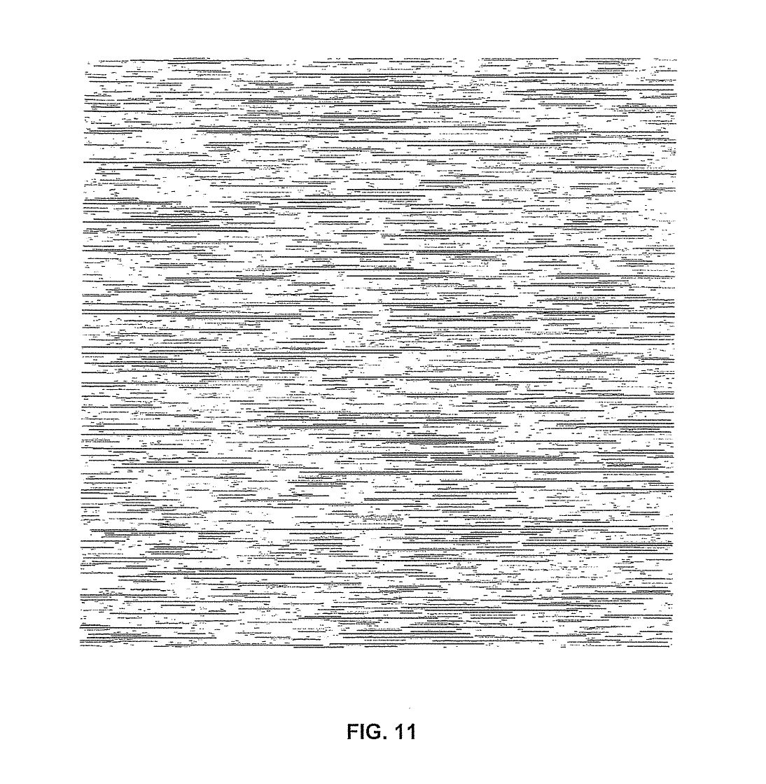

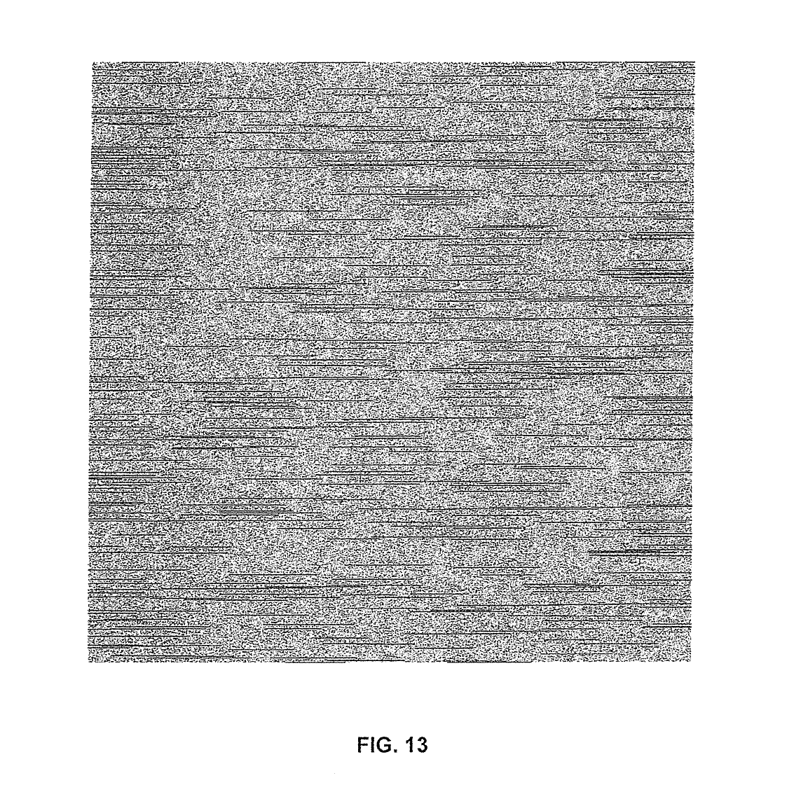

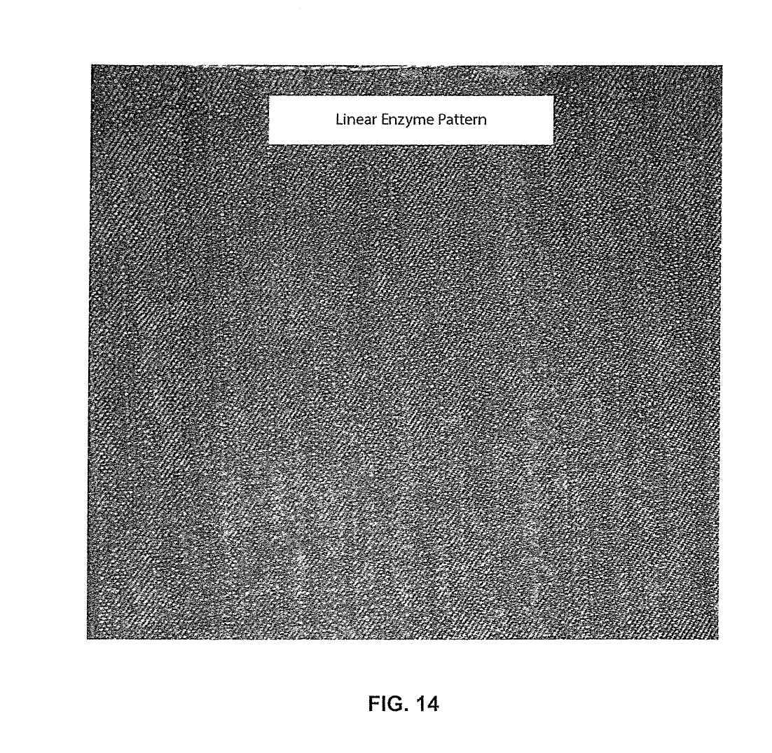

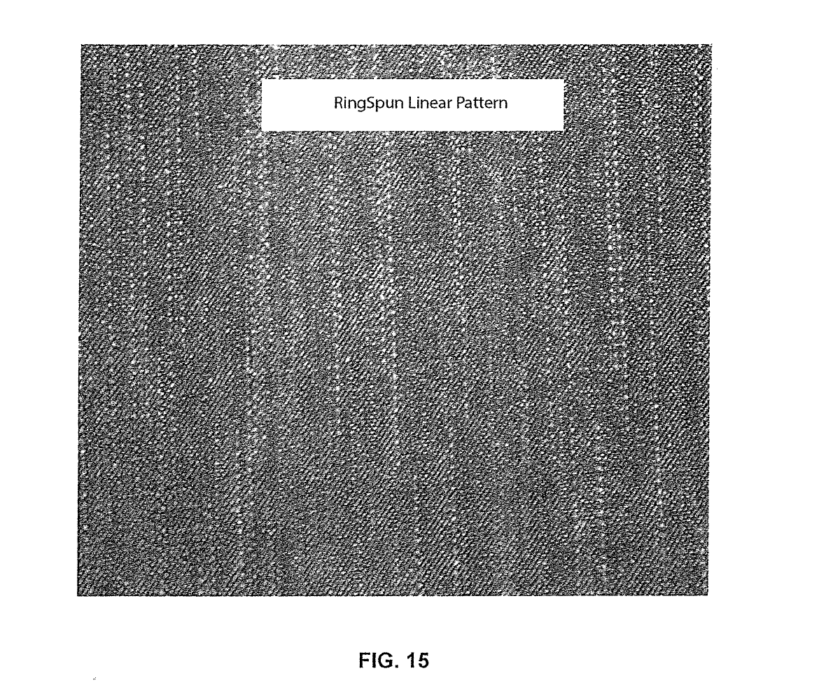

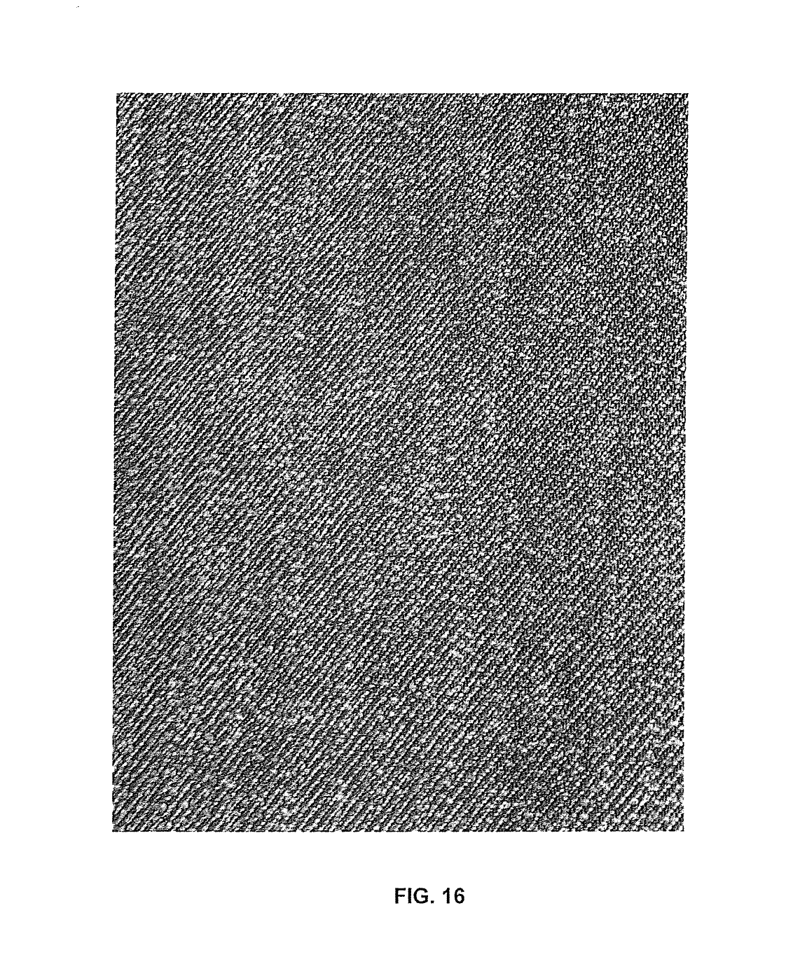

The method of generating a pattern described above can be used to generate various types of patterns to be processed within a surface of a fabric. For example, a generated pattern for a stonewash and enzyme pattern is illustrated in FIG. 10 and a resulting surface of a fabric after the surface has been processed using the pattern of FIG. 10 is illustrated in FIG. 14. A generated pattern for a ring spun pattern is illustrated in FIG. 11 and a resulting surface of a fabric after the surface has been processed using the pattern of FIG. 11 is illustrated in FIG. 15. It is noted that the ring spun pattern can be lazed upon a conventional denim material such as inexpensive open ended denim to create an image that replicates the appearance of expensive ring spun or loomed woven fabric. A generated pattern for a combination of a stonewash enzyme pattern and a ring spun pattern is illustrated in FIG. 13 and a resulting surface of a fabric after the surface has been processed using the pattern of FIG. 13 is illustrated in FIG. 16.

The ring spun pattern can be generated by defining the laser irradiation unit area to have the shape of a line where various parameters of the line can be selected. At least one of a minimum line width, a maximum line width, a minimum line length, and a maximum line length can be selected. The selected laser irradiation unit density results in various lines being selected having variable widths and lengths.

The number of lines and the number of lines of each length included within a ring spun pattern can be randomly determined where the ratio between each line having a different length can be the same or different. For example, when a laser irradiation unit density is selected, a random number of lines are selected such that the total number of pixels associated with laser irradiation unit indicators corresponds to the selected density. Then the number of lines and the number of line at each different length are selected to approximate the total number of pixels to include laser irradiation unit indicators. In an exemplary embodiment, the placement of each randomly determined line within the pattern area is performed by determining the probability whether a row within the pixel area will include a line. When it is determined that the row does not get a line, the next adjacent row is checked to determine the probability of whether the row should include a line. When it is determined that a row does get a line, a line is randomly arranged within the row of the pattern area, two adjacent rows are skipped and the determination of whether a line is arranged within that row is performed. When an overlap check is on, the overlap count is incremented for each pixel that overlaps another line. When the overlap count exceeds a predetermined threshold, a line is not placed within that row. In addition, when another line is within a minimum number of skip pixels from the left or right of the line, it is skipped.

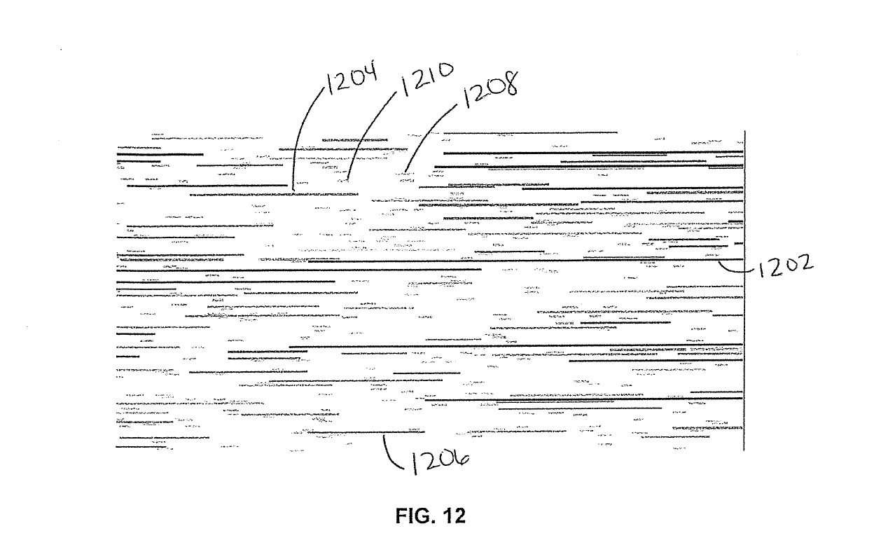

For example, FIG. 12 illustrates a magnified portion of the ring spun pattern illustrated in FIG. 11. A first laser irradiation unit area 1202 is selected to have a first length, a second irradiation unit area 1204 is selected to have a second length less than the first length, a third irradiation unit area 1206 is selected to have a third length less than the second length, a fourth irradiation unit area 1208 is selected to have a fourth length less than the third length, and a fifth irradiation unit area 1210 is selected to have a fifth length less than the fourth length. While each of the irradiation unit areas 1202, 1204, 1206, 1208, 1210 appear to have the same width, one of ordinary skill in the art would recognize that a variable width can also be utilized. One or more effective applied powers can be selected for the laser irradiation unit indicators within a single line. In an exemplary embodiment, each different laser irradiation unit area can be created simultaneously within the pattern area. For example, a plurality of different lines having different lengths can be provided within the pattern area at the same time. Alternatively, each different laser irradiation unit can be provided within the pattern area at a different time.

In an exemplary embodiment, when the surface of the fabric is processed based on the ring spun pattern, the frequency of the laser can be reduced at the laser itself. Specifically, separate from the identified effective applied power levels associated with the image created at the pattern generating device, the frequency of the laser may be reduced whereby the pattern created within the surface of the fabric does not include at least some of the pixels within a line associated with the generated pattern. Instead, due to the reduction in frequency of the laser beam, the resulting pattern created on the surface of the fabric includes non-processed portions between processed portions when a line within the pattern exceeds a predetermined length. All of the elements that are less than the predetermined length are processed such that the resulting pattern on the surface of the fabric directly corresponds to the pattern generated at the pattern generation device 102. Frequency reduction at the laser may be an effective way to increase processing speed to create the image on the surface of the fabric because rather than having to process each pixel individually to create an image having non-processed portions between adjacent processed portions, a single line within the pattern can be processed to create the same image having non-processed portions.

When two or more different patterns are overlapped within the same pattern area, for example, as illustrated in FIG. 13 where a stonewash enzyme pattern is overlapped with a ring spun pattern, different effective applied powers can be identified for each pattern. For example, a first range of effective applied powers can be identified with first laser irradiation unit indicators associated with a first pattern and a second range of effective applied powers can be identified with second laser irradiation unit indicators associated with a second pattern. In an exemplary embodiment, the first pattern can be a stonewash enzyme pattern and the second pattern can be a ring spun pattern where the first range of effective applied powers associated with the stonewash enzyme pattern can be less than the second range of effective applied powers associated with the ring spun pattern and vis versa. Alternatively, the same effective applied powers can be identified for both patterns.

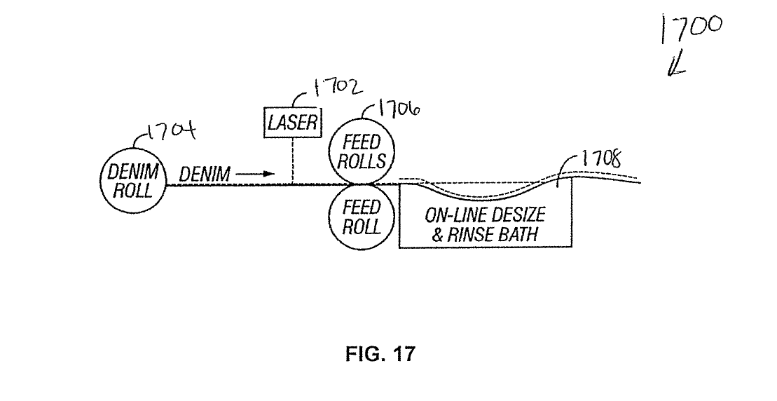

The above-described methods of generating a pattern used to process a surface of a fabric through laser irradiation can be used in various laser processing systems. For example, as illustrated in FIG. 17, system 1700 includes a laser 1702 used to process a surface of the fabric based on the generated pattern is mounted over a cutting table and one or more lasers can scribe the patterns onto the fabric. When a plurality of lasers is implemented, one or more lasers can translate across the width of the denim roll or one or more lasers can translate along the machine direction (e.g., in the direction of the length of the denim). Specifically, the fabric can be fed onto the cutting table from a denim roll 1704 using feed rolls 1706. In one embodiment, no further processing is necessary.

In another exemplary embodiment, the fabric can be further processed or washed using a rinse. For example, the fabric can be exposed to a conventional residential laundering process using a washing machine and detergent. Alternatively, the processed fabric can be further processed using a desizing agent or enzyme rinse. Specifically, the fabric can be washed in the on-line desize and rinse bath 1708. In an alternative embodiment, the fabric can be separately washed after assembly of the garment made using the fabric where the garment can include jeans, jackets, caps, etc. Implementation of the invention has the desired effect of minimizing if not eliminating a need to launder or otherwise wet process the lazed fabric.

In an exemplary embodiment, the method of processing a surface of a fabric through laser irradiation can create a fabric where the fabric is made of a woven material (such as denim). The woven material can include a plurality of yarns. Because the laser impinges upon an exposed surface of the woven material, the dye on the yarns associated with that surface are modified. Other surfaces of the woven fabric, and other threads not exposed to laser irradiation retain the original color of the fabric. In other words, in dry processing techniques, after the fabric is processed to include an image associated with a pattern generated as described above, only the surface in which the laser impinges is processed. The surface of the fabric that is not exposed to laser irradiation remains unchanged and no processing is present within that surface. In contrast, wet processing techniques treat both sides of the fabric such that a change in mechanical and/or chemical properties is introduced to each side of the fabric.

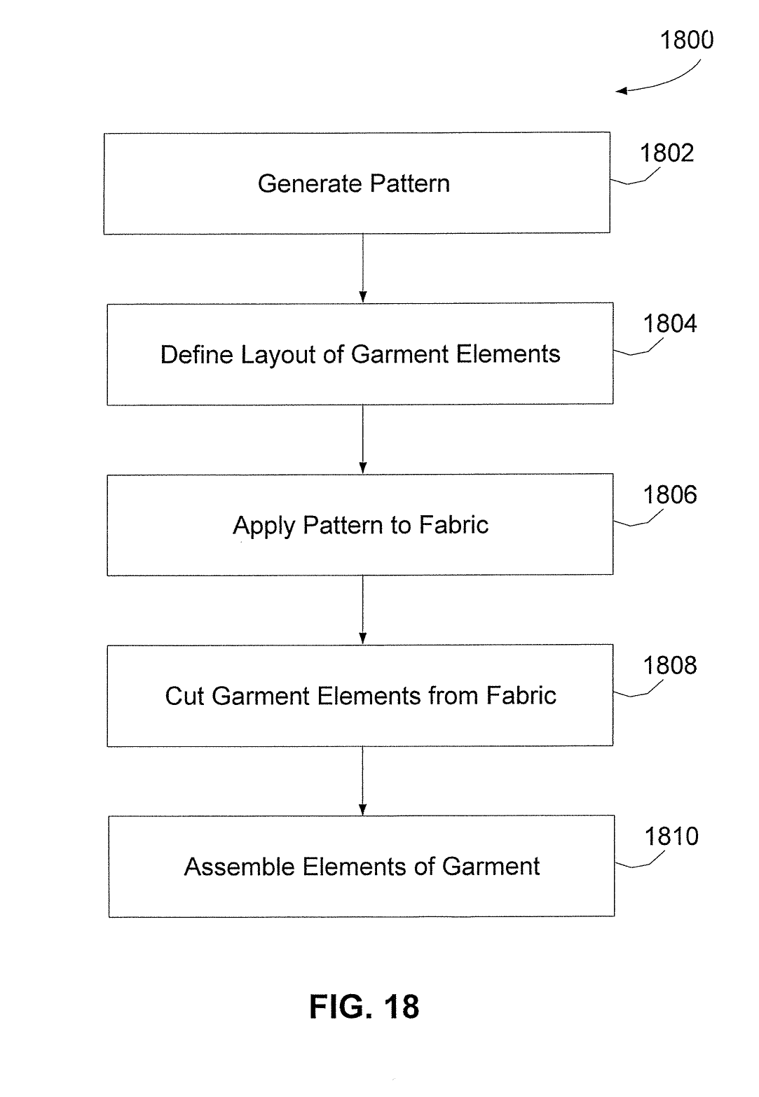

FIG. 18 illustrates a flow chart of an exemplary method 1800 for manufacturing a garment from a fabric where the fabric includes a surface processed using laser irradiation. The method will be discussed with reference to the exemplary system 100 and 1700 illustrated in FIGS. 1 and 17. However, the method can be implemented with any suitable system. In addition, although FIG. 18 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, and/or adapted in various ways.

At 1802, a pattern is generated at a pattern generation device. For example, a photo-deterioration pattern (e.g., a pattern that when applied to the surface of a fabric reduces the level of dye intensity) such as one described above can be generated at pattern generation device 102. Alternatively or in addition to the photo-deterioration pattern, a material deterioration process can be generated such as an abrasion technique simulating sandblasting or hand sanding that, when applied to the fabric, creates the desirable “worn look” by modifying the tensile and tear properties of the fabric. It is noted that the material deterioration process affects the tensile and tear properties more than the photo-deterioration technique.

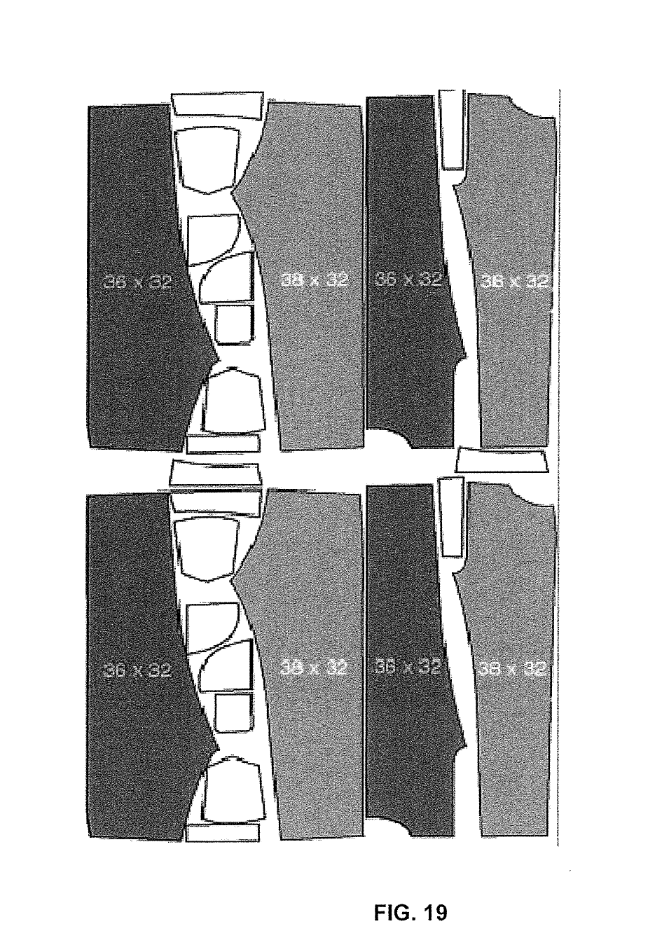

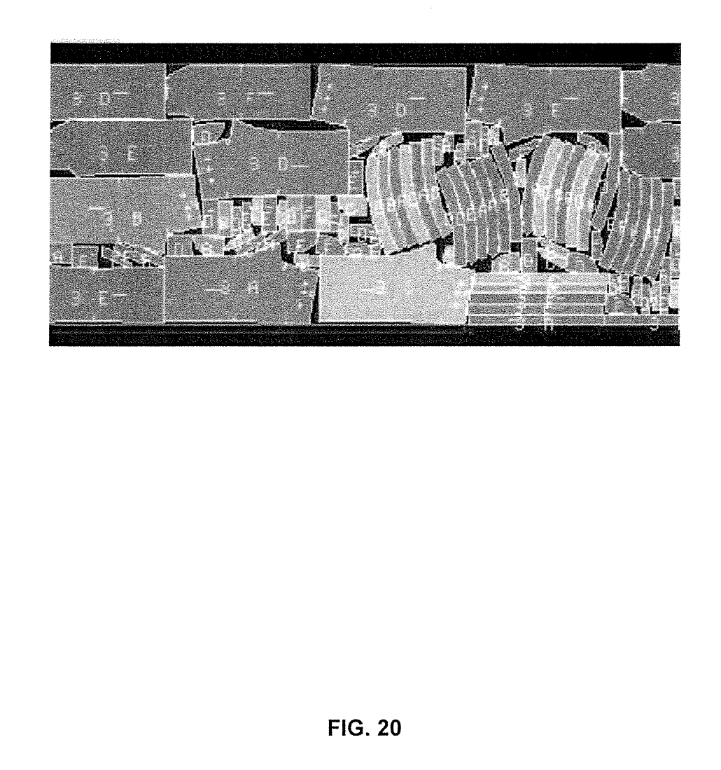

A layout of garment elements is defined at 1804. For example, markers or templates can be created where each marker or template is associated with each element of the garment. The markers are arranged to correspond to the fabric. This arrangement can be done using a physical marker or creating an arrangement virtually within a software program. Exemplary layouts are illustrated in FIGS. 19 and 20.

At 1806, a pattern is applied to the surface of the fabric. For example, after the markers are arranged with respect to the fabric to simulate the placement of each garment element, at least one of the photo-deterioration pattern and/or the material deterioration pattern is applied to the surface of the fabric associated with the garment element. In an exemplary embodiment, the photo-deterioration pattern and/or the material deterioration pattern can be integrated into the marker or template or it can be a separate image file. In addition to the photo-deterioration pattern and/or the material deterioration pattern, other patterns can be applied to the surface of the fabric such as lines indicating where the elements are to be sewn during assembly, alignment indicators, other markings, etc.

One or more lasers can be used to apply the pattern to the surface of the fabric. For example, one laser can be used to apply both the photo-deterioration pattern and the material deterioration patter. In another example, one or more lasers can be used to apply the photo-deterioration pattern and one or more other lasers can be used to apply the material deterioration pattern.

The garment elements can be cut from the fabric at 1808. For example, each element which has already been processed to include any desired photo-deterioration and/or material deterioration can be cut from the fabric. The elements can be cut from the fabric using the laser or alternative mechanical cutting tools. When the elements are cut using the laser, the laser used to cut the fabric can be the same laser or a different laser from the laser used to apply the pattern to the surface of the fabric. In an exemplary embodiment, a plurality of layers of fabric can be stacked on top of each other on the cutting table prior to cutting the elements from the fabric. An alignment indicator can be used to ensure that each layer is properly aligned prior to cutting. For example, the alignment indicator can be a visual indicator visible on the surface of the fabric. Alternatively, the alignment indicator can be a hole formed in the fabric wherein an alignment member such as a dowel can be inserted within the hole in each fabric layer to align the layers prior to cutting.

At 1810, the elements of the garment are assembled. In an exemplary embodiment, the resulting garment can be further processed using a wet processing technique such as laundering, enzyme and stone wash, etc. While we prefer that the dye modification techniques disclosed herein be applied to the roll of fabric, those skilled in the art will recognize that the laser irradiation to create a photo-deterioration pattern may be directed to the fabric on the roll, on garment components after being cut from an untreated roll, or to the finished garment.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

What is claimed is:

1. A method of generating a pattern used to process a surface of a fabric through laser irradiation, comprising the steps of:
defining a pattern area, wherein the pattern area includes an array of pixels;
defining a laser irradiation unit area, wherein the laser irradiation unit area comprises at least one pixel;
selecting a laser irradiation unit density associated with the pattern area, wherein the irradiation unit density corresponds to a number of laser irradiation unit indicators included in the pattern area;
arranging a plurality of laser irradiation unit indicators within the pattern area based on the laser irradiation unit density and the defined laser irradiation unit area; and
identifying an effective applied power of the laser for each of the plurality of laser irradiation unit indicators.

2. The method of claim 1, wherein the laser irradiation unit area comprises a plurality of pixels.

3. The method of claim 1, wherein the plurality of the laser irradiation units are randomly arranged within the pattern area.

4. The method of claim 1, wherein the effective applied power of the laser is based on at least one of a power intensity, duty cycle, scan speed, frequency, pulse width, pulse period, beam spot size, and focal distance.

5. The method of claim 1, wherein the pattern generated creates a stonewash or enzyme pattern when applied on the surface of the fabric.

6. The method of claim 1, wherein the pattern generated creates a ring spun pattern when applied on the surface of the fabric.

7. The method of claim 1, wherein the plurality of laser irradiation unit indicators includes a plurality of first laser irradiation unit indicators and a plurality of second laser irradiation unit indicators where a first effective applied power is identified for each of the plurality of first laser irradiation unit indicators and a second effective applied power is identified for each of the plurality of second laser irradiation unit indicators.

8. The method of claim 7, wherein a number of the plurality of first laser irradiation unit indicators is different from a number of the plurality of second laser irradiation unit indicators.

9. The method of claim 7, wherein a number of the plurality of first laser irradiation unit indicators is equal to a number of the plurality of second laser irradiation unit indicators.

10. The method of claim 7, wherein the plurality of first laser irradiation unit indicators are associated with a first color intensity value and the plurality of second laser irradiation unit indicators are associated with a second color intensity value different from the first color intensity value.

11. The method of claim 7, wherein the plurality of first laser irradiation unit indicators are associated with a first pattern design element and the plurality of second laser irradiation units are associated with a second pattern design element different from the first pattern design element.

12. The method of claim 11, wherein the plurality of first laser irradiation unit indicators are associated with a stonewash or enzyme pattern and the plurality of second laser irradiation unit indicators are associated with a ring spun pattern.

13. The method of claim 12, wherein the first effective applied power is less than the second effective applied power.

14. The method of claim 1, further comprising:
defining a laser irradiation unit area shape, wherein the laser irradiation unit area shape is selected from the group consisting of a square, a circle, a slice, and a line.

15. The method of claim 1, further comprising:
defining a laser irradiation unit area shape as a line; and
defining at least one parameter of the laser irradiation unit area shape, wherein the at least one parameter of the laser irradiation unit area shape comprises a minimum line width, a maximum line width, a minimum line length, and a maximum line length.

16. The method of claim 12, wherein a random number of laser irradiation unit areas are arranged within the pattern area based on the selected laser irradiation unit density.

17. The method of claim 16, wherein the random number of laser irradiation unit areas include a random number of lengths.

18. The method of claim 1, wherein selecting the laser irradiation unit density associated with the pattern area comprises:
selecting a first laser irradiation unit density associated with the pattern area, wherein the first irradiation unit density corresponds to a first number of irradiation unit indicators included in the pattern area;
selecting a second laser irradiation unit density associated with the pattern area, wherein the second irradiation unit density corresponds to a second number of irradiation unit indicators included in the pattern area,
wherein the second number of irradiation unit indicators are selected after the first number of irradiation unit indicators are arranged within the pattern area and the second number of irradiation unit indicators are arranged within the pattern area based on the second laser irradiation unit density and the defined laser irradiation unit area.

19. The method of claim 18, wherein at least one of the second irradiation unit indicators overlaps at least one of the first irradiation unit indicators.

20. The method of claim 19, wherein the effective applied power associated with the second irradiation unit indicator is identified for each pixel comprising an overlapping second irradiation unit indicator.

21. A method of processing a surface of a fabric through laser irradiation, comprising the steps of:
receiving at a control device information associated with a pattern used to process a surface of a fabric through laser irradiation, wherein the information associated with the pattern includes
a defined pattern area having an array of pixels,
a defined laser irradiation unit area comprising at least one pixel,
an indication of an arrangement of a plurality of laser irradiation unit indicators within the pattern area based on a selected laser irradiation unit density and the defined laser irradiation unit area, where the laser irradiation unit density corresponds to a number of laser irradiation unit indicators included in the pattern area, and
an identification of an effective applied power of the laser for each of the plurality of laser irradiation unit indicators;
translating at the control device the information associated with the pattern to be irradiated onto the surface of the fabric into instructions for a laser control device; and
instructing a laser control device to irradiate the pattern onto the surface of the fabric.

22. The method of claim 21, wherein the control device instructs the laser control device to apply scan lines in a length direction of the fabric.

23. A system configured to process a surface of a fabric through laser irradiation, comprising:
a pattern generating device configured to receive instructions to generate a pattern to process a surface of a fabric through laser irradiation, wherein the pattern is generated by
defining a pattern area at a pattern generating interface at the pattern generating device, wherein the pattern area includes an array of pixels,
defining a laser irradiation unit area, wherein the laser irradiation unit area comprises at least one pixel,
selecting a laser irradiation unit density associated with the pattern area within the pattern generating interface, wherein the irradiation unit density corresponds to a number of laser irradiation unit indicators included in the pattern area,
arranging a plurality of laser irradiation unit indicators within the pattern area based on the laser irradiation unit density and the defined laser irradiation unit area, and
identifying an effective applied power of the laser for each of the plurality of laser irradiation unit indicators;
a control device configured to receive instructions associated with the pattern generated at the pattern generating device; and
a laser control device configured to instruct a laser system to process the surface of the fabric based on the pattern generated at the pattern generating device.

24. A method of manufacturing a garment from a fabric processed using laser irradiation, comprising the steps of:
providing a fabric;
generating a pattern at a pattern generation device to create an image to be processed on a surface of the fabric;
defining a layout of elements of a garment corresponding to the fabric;
processing a surface of the fabric associated with at least one element of the garment using a laser to create the image associated with the pattern;
cutting the fabric after the image is processed in the surface of the fabric; and
assembling a plurality of the elements into a garment.

25. The method of claim 24, wherein the pattern is associated with at least one of a photo-deterioration pattern and a material deterioration pattern.

26. The method of claim 24, wherein generating a pattern at the pattern generation device comprises the steps of:
defining a pattern area, wherein the pattern area includes an array of pixels;
defining a laser irradiation unit area, wherein the laser irradiation unit area comprises at least one pixel;
selecting a laser irradiation unit density associated with the pattern area, wherein the irradiation unit density corresponds to a number of laser irradiation unit indicators included in the pattern area;
arranging a plurality of laser irradiation unit indicators within the pattern area based on the laser irradiation unit density and the defined laser irradiation unit area; and
identifying an effective applied power of the laser for each of the plurality of laser irradiation unit indicators.

27. A fabric, comprising
a woven material comprising a plurality of yarns, wherein the woven material includes a first surface and a second surface and an image is created in a first surface of the woven material using a pattern generated by the method of claim 1.

28. An article of laser etched denim, comprising:
a woven denim material comprising a plurality of yarns, wherein the woven material includes a first surface and a second surface and an image is created in a first surface of the woven material using a pattern generated by the method of claim 1.

29. Use of a laser to apply an image to a surface of a fabric based on a pattern generated by the method of claim 1.
